(19) United States
(12) Patent Application Publication
(10) Pub. No.: US 2013/0226687 A1
(43) Pub. Date: Aug. 29, 2013

(54) SYSTEMS AND METHODS FOR INTERMEDIARY PRICING AND RETAIL SALES OF COMMODITIES

(71) Applicant: Neighborhood Marketing, Inc., (US)

(72) Inventors: Robin Perry, Central Valley, NY (US); Paul Harkins, Central Valley, NY (US)

(73) Assignee: NEIGHBORHOOD MARKETING, INC., Andover, MA (US)

(21) Appl. No.: 13/774,824

(22) Filed: Feb. 22, 2013

Related U.S. Application Data
(60) Provisional application No. 61/602,441, filed on Feb. 23, 2012.

(51) Int. Cl. G06Q 30/02

(52) U.S. Cl. CPC G06Q 30/0233
USPC 705/14.33

(57) ABSTRACT

The present disclosure describes systems and methods for improved commodity pricing and sales. An intermediary system may contract with a plurality of providers to provide a fungible commodity to consumers at a first predetermined price. The intermediary system may also contract with a plurality of consumers to provide the fungible commodity at a second predetermined price. The intermediary system may determine the second predetermined price responsive to a customer point balance, points earned by the consumer performing one or more actions, including social networking functions, grassroots advertising, or purchasing predetermined amounts with third-party affiliated retailers.

### RELATED APPLICATION

The present application claims the benefit of and priority to U.S. Provisional Application No. 61/602,441, entitled “Systems and Methods Intermediary Pricing and Retail Sales of Commodities” and filed on Feb. 23, 2012, which is incorporated herein by reference in its entirety for all purposes.

### FIELD OF THE INVENTION

The present disclosure relates to systems and methods for commodity pricing and sales. In particular, the present disclosure relates to methods and systems for an improved commodity retail system.

### BACKGROUND

Consumer markets for fungible commodities tend to be highly fractured. For example, the home heating oil market includes more than 22,000 local providers, none of whom have more than 4% of the market, which includes over 9 million U.S. households purchasing an average of 900 gallons per year. Due to contract lock-in, as well as natural tendencies of consumers to stay with particular providers, the ability of consumers to find the lowest prices is greatly hindered. Furthermore, with necessary commodities such as heating oil, consumers frequently enter into long-term delivery contracts in which a local dealer periodically delivers fuel and bills the consumer afterwards, at a relatively ambiguous market rate. Accordingly, customers may not realize potential savings through competitive price differences.

### SUMMARY

An intermediary retailer for purchase of commodities and services, between consumers and wholesale and local providers, enables consumers to earn points and use those points as cash to reduce the price of the commodities and services. Points may reduce the price paid at checkout, regardless of where the customer lives, freeing the customer from being tied to geographic price monopolies. Points may be earned through various activities, including social networking behavior, shopping at affiliated retailers, or other means. The customer's purchase and point earning history can be analyzed to provide exclusive rewards or point earning opportunities, targeted advertising or recommendations, or other analytically-based features. Thus, in summary, the systems and methods discussed herein create an online price-transparent platform where consumers can purchase commodities or recurring services, such as home heating oil, natural gas, propane, electricity, internet service, cable service, lawn service, tax services, in-home cleaning services, dry cleaning services, or any other type and form of commodity or service, paid for or subsidized through the use of points earned through various activities, including social networking, third-party retail purchases, or other functions.

In one aspect, the present disclosure is directed to systems and methods for improved commodity pricing and sales. An intermediary system may contract with a plurality of providers to provide a fungible commodity to consumers at a first predetermined price. The intermediary system may also contract with a plurality of consumers to provide the fungible commodity at a second predetermined price. The intermediary system may determine the second predetermined price responsive to a customer point balance, points earned by the consumer performing one or more actions. In some embodiments, points may be awarded responsive to social networking functions, grassroots advertising, or similar actions. In other embodiments, points may be awarded responsive to the consumer's consumption of the commodity relative to a predetermined consumption rate. For example, in one such embodiment, a consumer may earn points by using less than a predetermined amount of heating oil within a predetermined time frame. This may create a “reverse” bulk discount, whereby a consumer may receive a discount through conservation. Such discounts may be priced to correspond to the reduced delivery costs of the providers, the reduced demand through conservation, or similar relationships. In some embodiments, points may provide for loyalty rewards for disparate local services. For example, consumer purchases via retail partners may be awarded with points applicable to purchase of the fungible commodities.

The fungible commodity may comprise home heating oil, natural gas, propane, electricity, or any other commodity. In some embodiments, commodity-like services may be purchased, such as internet service, cable service, or phone service. In still other embodiments, recurring services may be purchased, such as dry cleaning service, in-home cleaning service, tax service, or any other type and form of service. Thus, one skilled in the art may readily appreciate how the examples discussed herein may be applied to purchase and sales of any good or service.

Furthermore, by serving as a single intermediary for a plurality of consumers and a plurality of commodity providers, the intermediary system may allow for smoothing of market prices across diverse geographic markets. For example, in some embodiments, the intermediary system may provide a single nationwide price or a few regional prices, rather than local prices which may be highly volatile responsive to local supply. This may help to increase market transparency.

In another aspect, the present disclosure is directed to systems and methods for using cash credits earned from consumer activity to pay for a purchase of a service of a service provider. A server acting as an intermediary between a plurality of consumers and one or more service providers identifies a points balance of the consumer for an account of a consumer of the plurality of consumers maintained by the server. The points of the point balance are earned by the consumer by taking actions that are external to and tracked by the server and not related to the one or more service providers. In some implementations, the actions taken by the consumer include actions taken by the consumer through one or more social network accounts of the consumer.

A request is received from the consumer to purchase a service of a service provider of the one or more service providers for which the server acts as the intermediary. In some implementations, the service being purchased can be provided by more than one service provider of the one or more service providers. A cash value converted from points of the points balance is then credited to the account of the consumer a cash value. The cash value is applicable as payment to the one or more service providers for the purchase of one or more services. In response to the request to purchase the service, an indication of the cash value available to the consumer from the points balance for use as payment and a bill for a purchase price of the service is provided. In response to the consumer selecting to pay the bill with at least a portion of the cash value from the points balance, the portion of the cash value is applied to pay the bill for the purchase price of the service. In some implementations, the server provides an updated amount to be paid corresponding to a difference between an amount of the bill and the portion of the cash value applied towards the bill.

In some implementations, the actions taken by the consumer at one or more third party web-sites not related to the one or more service providers is received by the server. The server then assigns points to each of the actions. The points balance of the consumer is then updated to include the assigned points.

In some implementations, the server identifies a number of points in the points balance, multiplies the number of points by a points-to-cash conversion rate to generate the cash value adds the cash value to the account of the consumer and removes the points in the points balance used to generate the cash value.

In some implementations, the server identifies the service providers of the one or more service providers providing the service. The service provider providing the service at a lowest price is selected and a bill corresponding to the selected service provider is provided to the consumer purchasing the service. In some implementations, the server identifies a lowest price at which one of the one or more service providers is willing to provide the service. A purchase price greater than the lowest price by a predetermined amount of the service is then determined.

In some implementations, the one or more service providers includes any of the following: a heating oil provider supplying heating oil, an electric utility provider supplying electricity, a water supplier supplying water, a telephone company providing telecommunications services, an internet service provider providing internet services, a television cable company providing television-related services and a health care provider providing health care services.

The details of various embodiments of the invention are set forth in the accompanying drawings and the description below.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a diagrammatic view of a commodity market;

FIG. 1B is a diagrammatic view of a commodity market incorporating an improved commodity retailer;

FIG. 2A is a block diagram depicting an embodiment of a network environment comprising local machines in communication with remote machines;

FIGS. 2B-2E are block diagrams depicting embodiments of computers useful in connection with the methods and systems described herein;

FIG. 3 is a block diagram of an embodiment of a system for an improved commodity retailer;

FIGS. 4A-4E are example screenshots of embodiments of a portal for commodity purchasing; and

FIG. 4F is an example screenshots of an embodiment of a client agent user interface for monitoring point earning opportunities.

FIG. 5 is a flow diagram of an embodiment of a method for using cash credits earned from consumer activity to pay for a purchase of a service of a service provider

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

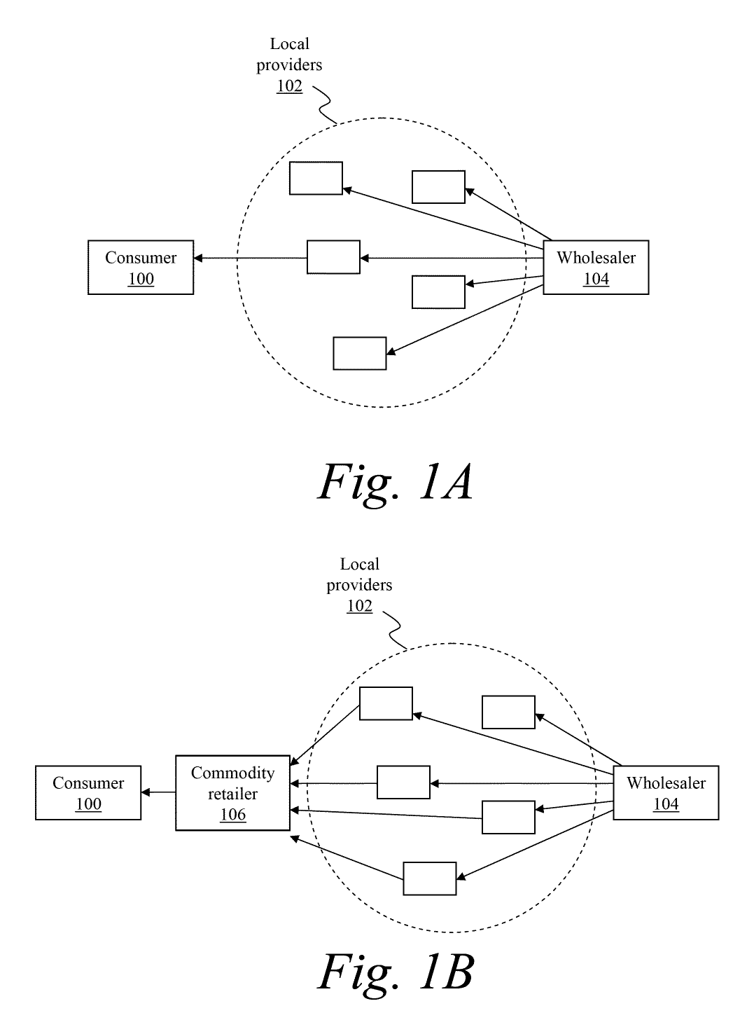

Referring first to FIG. 1A, illustrated is a diagrammatic view of a typical commodity market. One or more consumers 100 may purchase a fungible commodity from one of a plurality of local providers 102, who in turn purchase the commodity from one or more wholesalers 104. The fungible commodity may comprise home heating oil, natural gas, propane, electricity, or any other commodity. In some embodiments, commodity-like services may be purchased, such as internet service, cable service, or phone service. In still other embodiments, recurring services may be purchased, such as dry cleaning service, in-home cleaning service, tax service, or any other type and form of service. Thus, one skilled in the art may readily appreciate how the examples discussed herein may be applied to any good or service. While various local providers 102 may provide different price rates for the commodity, it may be difficult for consumers 100 to compare prices, due to the lack of a unified price database, diverse pricing standards (e.g. short term contracts vs. long term contracts, prices including delivery charges or fees vs. prices on just the commodity, etc.). Additionally, as the commodity may be a necessity with service disruptions resulting in adverse consequences, many consumers will enter into long-term delivery contracts with a single provider 102 at potentially higher rates. Price differences between providers 102 may be due to differences in consumer demand with consumers contracting with each provider 102, differences in amounts of the commodity purchased from the wholesaler or wholesalers 104, differences in margin or overhead at each provider, etc. Accordingly, transparency and comparison is difficult for consumers.

Referring now to FIG. 1B, illustrated is a diagrammatic view of an improved commodity market incorporating an intermediary pricing system or commodity retailer 106. Commodity retailer 106 may contract with a plurality of local providers 102, and contract with a plurality of consumers 100. The commodity retailer 106 may provide a single price, eliminating differences in pricing between local providers 102. Because the commodity is fungible, to fulfill any particular consumer order, different providers 102 may be selected responsive to individual provider supply (and correspondingly, individual provider price), resulting in the lowest possible price for the consumer contract. In some embodiments, local providers may still deliver the commodity to the consumer, with the commodity retailer 106 providing purchasing and billing systems. This may also reduce expenses for each local provider 102, as well as take advantage of bulk transaction discounts with banks or credit card providers. In some embodiments, commodity retailer 106 may realize profit through price differences between retail prices paid by consumers 100 and wholesale prices paid to local providers 102. By aggregating orders from consumers 100, retailer 106 may be able to get wholesale pricing from said local providers 102.

In some embodiments, consumers 100 may be able to earn points through various actions, with points subsidizing or reducing price of the commodity. For example, in one embodiment, a user may reduce the price of heating oil by 10 cents per gallon by spending or using one hundred points. Points may be earned, in some embodiments, through social networking activities. For example, in one such embodiment, a consumer may earn points by inviting friends or neighbors to join the commodity retailer 106's system. In another example embodiment, a consumer may earn points by blogging or discussing ways to reduce energy consumption on an online forum. In yet another example embodiment, a consumer may earn points by participating in market surveys or energy consumption surveys.

In other embodiments, points may be earned through purchases from the commodity retailer 106. For example, in one such embodiment, a consumer 100 may earn 10 points for every kilowatt-hour of electricity purchased from retailer 106. In still other embodiment, points may be earned through purchases from affiliated or associated retailers. For example, retailer 106 may partner with retailers in other markets or industries, such as electronic goods or clothing. A consumer may earn points with retailer 106 in exchange for purchasing a predetermined amount of goods from the partnered retailer. For example, in one such embodiment, for every $3.62 of clothing purchased from a clothing retailer, the user may receive 10 points. In a further embodiment, the partnered retailer may pay a predetermined amount per point earned or goods purchased to retailer 106. For example, when the user purchases $3.62 of clothing or earns 10 points through purchases at a clothing retailer, the clothing retailer may pay two cents to the retailer 106, accordingly subsidizing the consumer's points. The clothing retailer may benefit through increased advertising through commodity retailer 106's system reaching new customers, as well as existing customers being driven through loyalty rewards to increase purchases through partnered retailers.

In other embodiments, points may be awarded responsive to the consumer's consumption of the commodity relative to a predetermined consumption rate. For example, in one such embodiment, a consumer 100 may earn points by using less than a predetermined amount of a commodity within a predetermined time frame. This may create a “reverse” bulk discount, whereby a consumer may receive a discount through conservation. Such discounts may be priced to correspond to the reduced delivery costs of the providers, the reduced demand through conservation, or similar relationships.

In some embodiments, points may be transferred between consumers or to organizations. In one embodiment, a consumer may transfer earned points to friends, neighbors, or other consumers in need. For example, a consumer with a surplus of points may transfer a predetermined number of points to a second, elderly consumer with a fixed income, allowing for an indirect charitable gift by reducing the second consumer's energy costs. In a similar embodiment, the consumer may transfer points to a non-profit organization, who may then distribute the points as necessary to needy consumers.

In some embodiments, commodity retailer 106 may provide for long term delivery contracts with consumers 100, with automatic delivery based on a predetermined threshold, such as the level of heating oil in a consumer's storage tank; based on consumer specifications, such as 25 gallons per month, or 50 gallons whenever the average ambient temperature is below a threshold temperature for more than a predetermined amount of time; analytics, such as average use over a period of time; or any other metric. In some embodiments in which consumer storage tanks are used, such as with heating oil, said tanks may comprise automatic level detectors. In one embodiment, the commodity retailer 106 may utilize a portal, such as a web page or application interface, to display the consumer's current tank level to the consumer 100, such that the consumer may make a determination to purchase more of the commodity. In some embodiments, commodity retailer 106 may partner with a provider of carbon offset certificates to provide certificates to consumers purchasing carbon offset credits at the point of sale.

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for an improved commodity retailer.

A. Computing and Network Environment

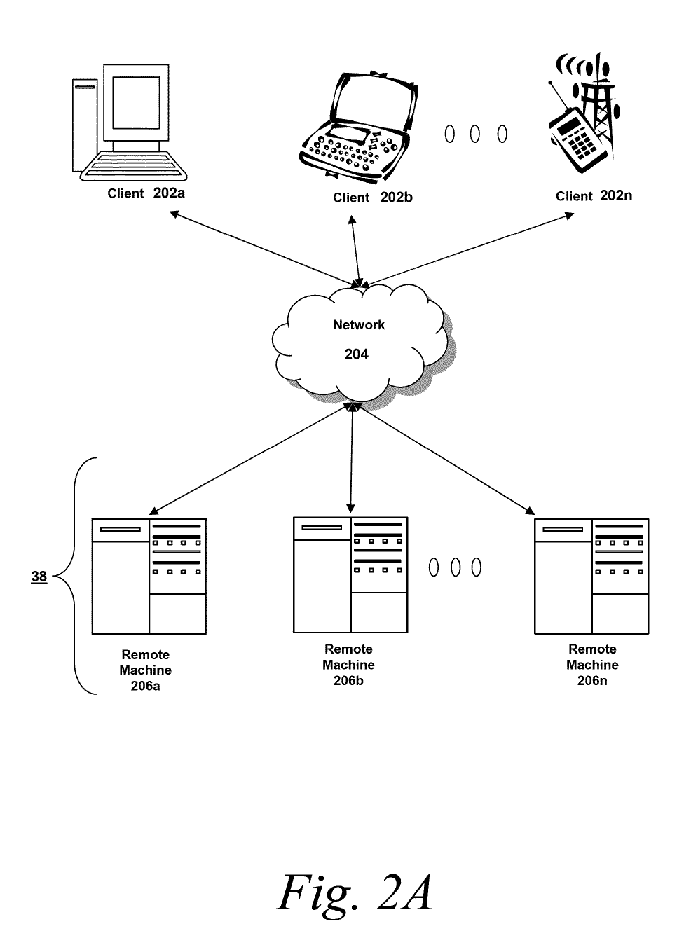

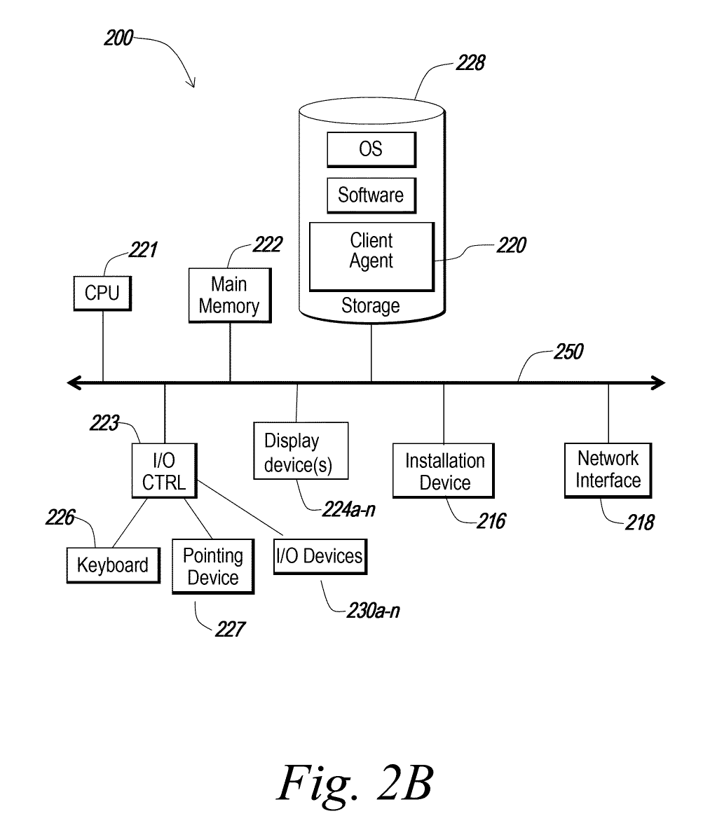

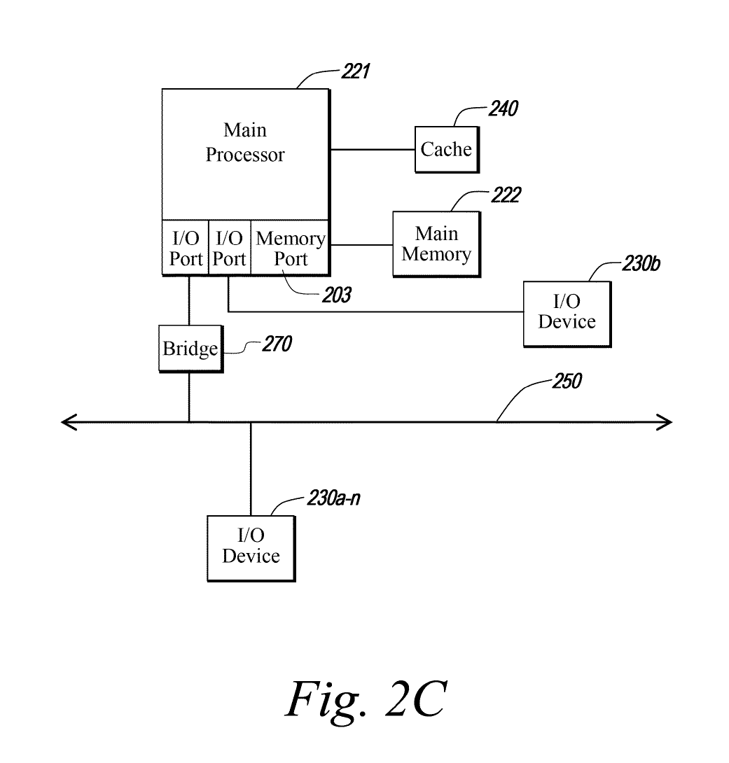

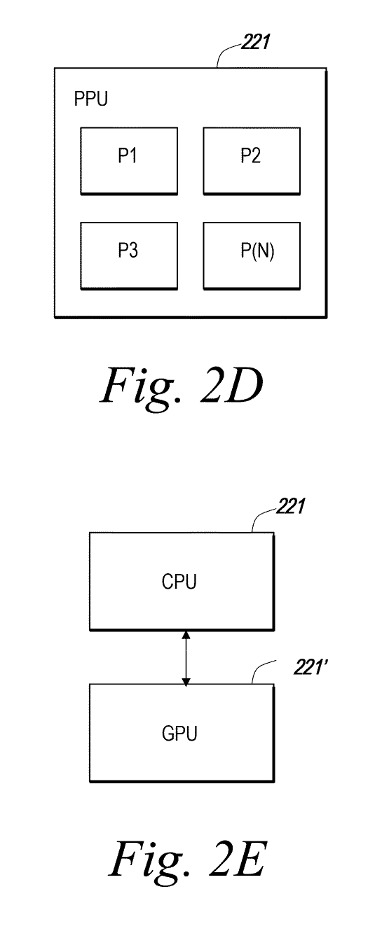

Prior to discussing specifics of methods and systems for an improved intermediary commodity retail system, it may be helpful to briefly discuss embodiments of networks and computing devices that may be utilized in various embodiments of these methods and systems. Referring now to FIG. 2A, an embodiment of a network environment is depicted. In brief overview, the network environment comprises one or more local machines 202a-202n (also generally referred to as local machine(s) 202, client(s) 202, client node(s) 202, client machine(s) 202, client computer(s) 202, client device(s) 202, endpoint(s) 202, or endpoint node(s) 202) in communication with one or more remote machines 206a-206n (also generally referred to as server(s) 206 or remote machine(s) 206) via one or more networks 204. In some embodiments, a local machine 202 has the capacity to function as both a client node seeking access to resources provided by a server and as a server providing access to hosted resources for other clients 202a-202n.

Although FIG. 2A shows a network 204 between the local machines 202 and the remote machines 206, the local machines 202 and the remote machines 206 may be on the same network 204. The network 204 can be a local-area network (LAN), such as a company Intranet, a metropolitan area network (MAN), or a wide area network (WAN), such as the Internet or the World Wide Web. In some embodiments, there are multiple networks 204 between the local machines 202 and the remote machines 206. In one of these embodiments, a network 204′ (not shown) may be a private network and a network 204 may be a public network. In another of these embodiments, a network 204 may be a private network and a network 204′ a public network. In still another embodiment, networks 204 and 204′ may both be private networks. In yet another embodiment, networks 204 and 204′ may both be public networks.

The network 204 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 204 may comprise a wireless link, such as an infrared channel or satellite band. The topology of the network 204 may be a bus, star, or ring network topology. The network 204 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped remote machines 206. In one of these embodiments, the logical group of remote machines may be referred to as a server farm 38. In another of these embodiments, the remote machines 206 may be geographically dispersed. In other embodiments, a server farm 38 may be administered as a single entity. In still other embodiments, the server farm 38 comprises a plurality of server farms 38. The remote machines 206 within each server farm 38 can be heterogeneous—one or more of the remote machines 206 can operate according to one type of operating system platform (e.g., WINDOWS NT, WINDOWS 2003, WINDOWS 2008, WINDOWS 7 and WINDOWS Server 2008 R2, all of which are manufactured by Microsoft Corp. of Redmond, Wash.), while one or more of the other remote machines 206 can operate on according to another type of operating system platform (e.g., Unix or Linux).

The remote machines 206 of each server farm 38 do not need to be physically proximate to another remote machine 206 in the same server farm 38. Thus, the group of remote machines 206 logically grouped as a server farm 38 may be interconnected using a wide-area network (WAN) connection or a metropolitan-area network (MAN) connection. For example, a server farm 38 may include remote machines 206 physically located in different continents or different regions of a continent, country, state, city, campus, or room. Data transmission speeds between remote machines 206 in the server farm 38 can be increased if the remote machines 206 are connected using a local-area network (LAN) connection or some form of direct connection.

A remote machine 206 may be a file server, application server, web server, proxy server, appliance, network appliance, gateway, application gateway, gateway server, virtualization server, deployment server, SSL VPN server, or firewall. In some embodiments, a remote machine 206 provides a remote authentication dial-in user service, and is referred to as a RADIUS server. In other embodiments, a remote machine 206 may have the capacity to function as either an application server or as a master application server. In still other embodiments, a remote machine 206 is a blade server. In yet other embodiments, a remote machine 206 executes a virtual machine providing, to a user or client computer 202, access to a computing environment.

In one embodiment, a remote machine 206 may include an Active Directory. The remote machine 206 may be an application acceleration appliance. For embodiments in which the remote machine 206 is an application acceleration appliance, the remote machine 206 may provide functionality including firewall functionality, application firewall functionality, or load balancing functionality. In some embodiments, the remote machine 206 comprises an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

In some embodiments, a remote machine 206 executes an application on behalf of a user of a local machine 202. In other embodiments, a remote machine 206 executes a virtual machine, which provides an execution session within which applications execute on behalf of a user of a local machine 202. In one of these embodiments, the execution session is a hosted desktop session. In another of these embodiments, the execution session provides access to a computing environment, which may comprise one or more of: an application, a plurality of applications, a desktop application, and a desktop session in which one or more applications may execute.

In some embodiments, a local machine 202 communicates with a remote machine 206. In one embodiment, the local machine 202 communicates directly with one of the remote machines 206 in a server farm 38. In another embodiment, the local machine 202 executes a program neighborhood application to communicate with a remote machine 206 in a server farm 38. In still another embodiment, the remote machine 206 provides the functionality of a master node. In some embodiments, the local machine 202 communicates with the remote machine 206 in the server farm 38 through a network 204. Over the network 204, the local machine 202 can, for example, request execution of various applications hosted by the remote machines 206a-206n in the server farm 38 and receive output of the results of the application execution for display. In some embodiments, only a master node provides the functionality required to identify and provide address information associated with a remote machine 206b hosting a requested application.

In one embodiment, the remote machine 206 provides the functionality of a web server. In another embodiment, the remote machine 206a receives requests from the local machine 202, forwards the requests to a second remote machine 206b and responds to the request by the local machine 202 with a response to the request from the remote machine 206b. In still another embodiment, the remote machine 206a acquires an enumeration of applications available to the local machine 202 and address information associated with a remote machine 206b hosting an application identified by the enumeration of applications. In yet another embodiment, the remote machine 206 presents the response to the request to the local machine 202 using a web interface. In one embodiment, the local machine 202 communicates directly with the remote machine 206 to access the identified application. In another embodiment, the local machine 202 receives output data, such as display data, generated by an execution of the identified application on the remote machine 206.

In some embodiments, the remote machine 206 or a server farm 38 may be running one or more applications, such as an application providing a thin-client computing or remote display presentation application. In one embodiment, the remote machine 206 or server farm 38 executes as an application any portion of the CITRIX ACCESS SUITE by Citrix Systems, Inc., such as the METAFRAME or CITRIX PRESENTATION SERVER products, any of the following products manufactured by Citrix Systems, Inc.: CITRIX XENAPP, CITRIX XENDESKTOP, CITRIX ACCESS GATEWAY, and/or any of the MICROSOFT WINDOWS Terminal Services manufactured by the Microsoft Corporation. In another embodiment, the application is an ICA client, developed by Citrix Systems, Inc. of Fort Lauderdale, Fla. In still another embodiment, the remote machine 206 may run an application, which, for example, may be an application server providing email services such as MICROSOFT EXCHANGE manufactured by the Microsoft Corporation of Redmond, Wash., a web or Internet server, or a desktop sharing server, or a collaboration server. In yet another embodiment, any of the applications may comprise any type of hosted service or products, such as GOTOMEETING provided by Citrix Online Division, Inc. of Santa Barbara, Calif., WEBEX provided by WebEx, Inc. of Santa Clara, Calif., or Microsoft Office LIVE MEETING provided by Microsoft Corporation of Redmond, Wash.

A local machine 202 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on local machine 202. In some embodiments, the application may be a server-based or a remote-based application executed on behalf of the local machine 202 on a remote machine 206. In other embodiments, the remote machine 206 may display output to the local machine 202 using any thin-client protocol, presentation layer protocol, or remote-display protocol, such as the Independent Computing Architecture (ICA) protocol manufactured by Citrix Systems, Inc. of Ft. Lauderdale, Fla.; the Remote Desktop Protocol (RDP) manufactured by the Microsoft Corporation of Redmond, Wash.; the X11 protocol; the Virtual Network Computing (VNC) protocol, manufactured by AT&T Bell Labs; the SPICE protocol, manufactured by Qumranet, Inc., of Sunnyvale, Calif., USA, and of Raanana, Israel; the Net2Display protocol, manufactured by VESA, of Milpitas, Calif.; the PC-over-IP protocol, manufactured by Teradici Corporation, of Burnaby, B.C.; the TCX protocol, manufactured by Wyse Technology, Inc., of San Jose, Calif.; the THINC protocol developed by Columbia University in the City of New York, of New York, N.Y.; or the Virtual-D protocols manufactured by Desktone, Inc., of Chelmsford, Mass. The application can use any type of protocol and it can be, for example, an HTTP client, an FTP client, an Oscar client, or a Telnet client. In still other embodiments, the application comprises any type of software related to voice over Internet protocol (VoIP) communications, such as a soft IP telephone. In further embodiments, the application comprises any application related to real-time data communications, such as applications for streaming video and/or audio.

The local machine 202 and remote machine 206 may be deployed as and/or executed on any type and form of computing device, such as a computer, network device or appliance capable of communicating on any type and form of network and performing the operations described herein. FIGS. 2B and 2C depict block diagrams of a computing device 200 useful for practicing an embodiment of the local machine 202 or a remote machine 206. As shown in FIGS. 2B and 2C, each computing device 200 includes a central processing unit 221, and a main memory unit 222. As shown in FIG. 2B, a computing device 200 may include a storage device 228, an installation device 216, a network interface 218, an I/O controller 223, display devices 224a-n, a keyboard 226 and a pointing device 227, such as a mouse. The storage device 228 may include, without limitation, an operating system, software, and a client agent 220. As shown in FIG. 2C, each computing device 200 may also include additional optional elements, such as a memory port 203, a bridge 270, one or more input/output devices 230a-230n (generally referred to using reference numeral 230), and a cache memory 240 in communication with the central processing unit 221.

The central processing unit 221 is any logic circuitry that responds to and processes instructions fetched from the main memory unit 222. In many embodiments, the central processing unit 221 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 200 may be based on any of these processors, or any other processor capable of operating as described herein.

Main memory unit 222 may be one or more memory chips capable of storing data and allowing any storage location to be directly accessed by the microprocessor 221, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 222 may be based on any of the above described memory chips, or any other available memory chips capable of operating as described herein. In the embodiment shown in FIG. 2B, the processor 221 communicates with main memory 222 via a system bus 250 (described in more detail below). FIG. 2C depicts an embodiment of a computing device 200 in which the processor communicates directly with main memory 222 via a memory port 203. For example, in FIG. 2C the main memory 222 may be DRDRAM.

FIG. 2C depicts an embodiment in which the main processor 221 communicates directly with cache memory 240 via a secondary bus, sometimes referred to as a backside bus. In other embodiments, the main processor 221 communicates with cache memory 240 using the system bus 250. Cache memory 240 typically has a faster response time than main memory 222 and is typically provided by SRAM, BSRAM, or EDRAM. In the embodiment shown in FIG. 2B, the processor 221 communicates with various I/O devices 230 via a local system bus 250. Various buses may be used to connect the central processing unit 221 to any of the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 224, the processor 221 may use an Advanced Graphics Port (AGP) to communicate with the display 224. FIG. 2C depicts an embodiment of a computer device 200 in which the main processor 221 communicates directly with I/O device 230b via HYPERTRANSPORT, RAPIDIO, or INFINIBAND communications technology. FIG. 2C also depicts an embodiment in which local busses and direct communication are mixed: the processor 221 communicates with I/O device 230a using a local interconnect bus while communicating with I/O device 230b directly.

A wide variety of I/O devices 230a-230n may be present in the computing device 200. Input devices include keyboards, mice, trackpads, trackballs, microphones, and drawing tablets. Output devices include video displays, speakers, inkjet printers, laser printers, and dye-sublimation printers. An I/O controller 223, as shown in FIG. 2B, may control the I/O devices. The I/O controller may control one or more I/O devices such as a keyboard 226 and a pointing device 227, e.g., a mouse or optical pen. Furthermore, an I/O device may also provide storage and/or an installation medium 216 for the computing device 200. In still other embodiments, the computing device 200 may provide USB connections (not shown) to receive handheld USB storage devices such as the USB Flash Drive line of devices manufactured by Twintech Industry, Inc. of Los Alamitos, Calif.

Referring again to FIG. 2B, the computing device 200 may support any suitable installation device 216, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 200 may further comprise a storage device, such as one or more hard disk drives or redundant arrays of independent disks, for storing an operating system and other related software, and for storing application software programs such as any program related to the client agent 220. Optionally, any of the installation devices 216 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 200 may include a network interface 218 to interface to the network 204 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 200 communicates with other computing devices 200′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 218 may comprise a built-in network adapter, network interface card, PCMCIA network card, card bus network adapter, wireless network adapter, USB network adapter, modem or any other device suitable for interfacing the computing device 200 to any type of network capable of communication and performing the operations described herein.

In some embodiments, the computing device 200 may comprise or be connected to multiple display devices 224a-224n, which each may be of the same or different type and/or form. As such, any of the I/O devices 230a-230n and/or the I/O controller 223 may comprise any type and/or form of suitable hardware, software, or combination of hardware and software to support, enable or provide for the connection and use of multiple display devices 224a-224n by the computing device 200. For example, the computing device 200 may include any type and/or form of video adapter, video card, driver, and/or library to interface, communicate, connect or otherwise use the display devices 224a-224n. In one embodiment, a video adapter may comprise multiple connectors to interface to multiple display devices 224a-224n. In other embodiments, the computing device 200 may include multiple video adapters, with each video adapter connected to one or more of the display devices 224a-224n. In some embodiments, any portion of the operating system of the computing device 200 may be configured for using multiple displays 224a-224n. In other embodiments, one or more of the display devices 224a-224n may be provided by one or more other computing devices, such as computing devices 200a and 200b connected to the computing device 200, for example, via a network. These embodiments may include any type of software designed and constructed to use another computer's display device as a second display device 224a for the computing device 200. One ordinarily skilled in the art will recognize and appreciate the various ways and embodiments that a computing device 200 may be configured to have multiple display devices 224a-224n.

In further embodiments, an I/O device 230 may be a bridge between the system bus 250 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus, or any other type and form of communication bus.

A computing device 200 of the sort depicted in FIGS. 2B and 2C typically operates under the control of operating systems, which control scheduling of tasks and access to system resources. The computing device 200 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS 7, WINDOWS CE, WINDOWS XP, and WINDOWS VISTA, all of which are manufactured by Microsoft Corporation of Redmond, Wash.; MAC OS, manufactured by Apple Inc., of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computing device 200 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 200 may have different processors, operating systems, and input devices consistent with the device. For example, in one embodiment, the computing device 200 is a TREO 180, 270, 600, 650, 680, 700p, 700w/wx, 750, 755p, 800w, Centro, or Pro smart phone manufactured by Palm, Inc. In some of these embodiments, the TREO smart phone is operated under the control of the PalmOS operating system and includes a stylus input device as well as a five-way navigator device.

In other embodiments the computing device 200 is a mobile device, such as a JAVA-enabled cellular telephone or personal digital assistant (PDA), such as the i55sr, i58sr, i85s, i88s, i90c, i95cl, i335, i365, i570, 1576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 200 is a mobile device manufactured by Nokia of Finland, or by Sony Ericsson Mobile Communications AB of Lund, Sweden.

In still other embodiments, the computing device 200 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 200 is a smart phone, Pocket PC, Pocket PC Phone, or other handheld mobile device supporting Microsoft Windows Mobile Software. Moreover, the computing device 200 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 200 comprises a combination of devices, such as a mobile phone combined with a digital audio player or portable media player. In one of these embodiments, the computing device 200 is a Motorola RAZR or Motorola ROKR line of combination digital audio players and mobile phones. In another of these embodiments, the computing device 200 is a device in the iPhone line of smartphones, manufactured by Apple Inc., of Cupertino, Calif. In still other embodiments, the computing device 200 may comprise a tablet computer, such as an iPad tablet computer manufactured by Apple, Inc., or any other type and form of tablet computer.

In one embodiment, a computing device 202a may request resources from a remote machine 206, while providing the functionality of a remote machine 206 to a client 202b. In such an embodiment, the computing device 202a may be referred to as a client with respect to data received from the remote machine 206 (which may be referred to as a server) and the computing device 202a may be referred to as a server with respect to the second client 202b. In another embodiment, the client 202 may request resources from the remote machine 206 on behalf of a user of the client 202.

As shown in FIG. 2D, the computing device 200 may comprise multiple processors and may provide functionality for simultaneous execution of instructions or for simultaneous execution of one instruction on more than one piece of data. In some embodiments, the computing device 200 may comprise a parallel processor with one or more cores. In one of these embodiments, the computing device 200 is a shared memory parallel device, with multiple processors and/or multiple processor cores, accessing all available memory as a single global address space. In another of these embodiments, the computing device 200 is a distributed memory parallel device with multiple processors each accessing local memory only. In still another of these embodiments, the computing device 200 has both some memory which is shared and some memory which can only be accessed by particular processors or subsets of processors. In still even another of these embodiments, the computing device 200, such as a multicore microprocessor, combines two or more independent processors into a single package, often a single integrated circuit (IC). In yet another of these embodiments, the computing device 200 includes a chip having a CELL BROADBAND ENGINE architecture and including a Power processor element and a plurality of synergistic processing elements, the Power processor element and the plurality of synergistic processing elements linked together by an internal high speed bus, which may be referred to as an element interconnect bus.

In some embodiments, the processors provide functionality for execution of a single instruction simultaneously on multiple pieces of data (SIMD). In other embodiments, the processors provide functionality for execution of multiple instructions simultaneously on multiple pieces of data (MIMD). In still other embodiments, the processor may use any combination of SIMD and MIMD cores in a single device.

In some embodiments, the computing device 200 may comprise a graphics processing unit. In one of these embodiments, depicted in FIG. 2E, the computing device 200 includes at least one central processing unit 221 and at least one graphics processing unit. In another of these embodiments, the computing device 200 includes at least one parallel processing unit and at least one graphics processing unit. In still another of these embodiments, the computing device 200 includes a plurality of processing units of any type, one of the plurality of processing units comprising a graphics processing unit.

In one embodiment, a resource may be a program, an application, a document, a file, a plurality of applications, a plurality of files, an executable program file, a desktop environment, a computing environment, or other resource made available to a user of the local computing device 202. The resource may be delivered to the local computing device 202 via a plurality of access methods including, but not limited to, conventional installation directly on the local computing device 202, delivery to the local computing device 202 via a method for application streaming, delivery to the local computing device 202 of output data generated by an execution of the resource on a third computing device 206b and communicated to the local computing device 202 via a presentation layer protocol, delivery to the local computing device 202 of output data generated by an execution of the resource via a virtual machine executing on a remote computing device 206, or execution from a removable storage device connected to the local computing device 202, such as a USB device, or via a virtual machine executing on the local computing device 202 and generating output data. In some embodiments, the local computing device 202 transmits output data generated by the execution of the resource to another client computing device 202b.

In some embodiments, a user of a local computing device 202 connects to a remote computing device 206 and views a display on the local computing device 202 of a local version of a remote desktop environment, comprising a plurality of data objects, generated on the remote computing device 206. In one of these embodiments, at least one resource is provided to the user by the remote computing device 206 (or by a second remote computing device 206b) and displayed in the remote desktop environment. However, there may be resources that the user executes on the local computing device 202, either by choice, or due to a policy or technological requirement. In another of these embodiments, the user of the local computing device 202 would prefer an integrated desktop environment providing access to all of the resources available to the user, instead of separate desktop environments for resources provided by separate machines. For example, a user may find navigating between multiple graphical displays confusing and difficult to use productively. Or, a user may wish to use the data generated by one application provided by one machine in conjunction with another resource provided by a different machine. In still another of these embodiments, requests for execution of a resource, windowing moves, application minimize/maximize, resizing windows, and termination of executing resources may be controlled by interacting with a remote desktop environment that integrates the display of the remote resources and of the local resources. In yet another of these embodiments, an application or other resource accessible via an integrated desktop environment—including those resources executed on the local computing device 202 and those executed on the remote computing device 206—is shown in a single desktop environment.

In one embodiment, data objects from a remote computing device 206 are integrated into a desktop environment generated by the local computing device 202. In another embodiment, the remote computing device 206 maintains the integrated desktop. In still another embodiment, the local computing device 202 maintains the integrated desktop.

In some embodiments, a single remote desktop environment 204 is displayed. In one of these embodiments, the remote desktop environment 204 is displayed as a full-screen desktop. In other embodiments, a plurality of remote desktop environments 204 is displayed.

In one of these embodiments, one or more of the remote desktop environments are displayed in non-full-screen mode on one or more display devices 224. In another of these embodiments, the remote desktop environments are displayed in full-screen mode on individual display devices. In still another of these embodiments, one or more of the remote desktop environments are displayed in full-screen mode on one or more display devices 224.

B. Improved Commodity Retailer

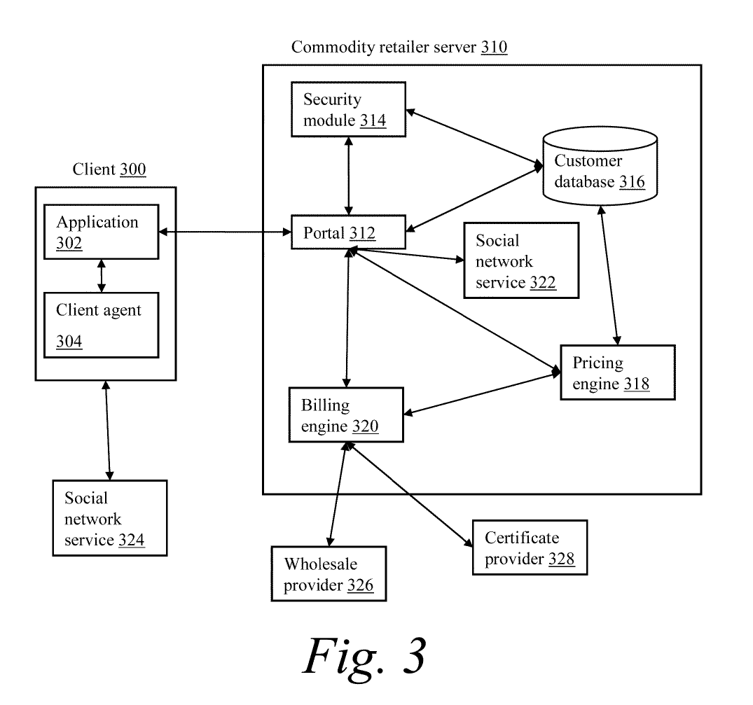

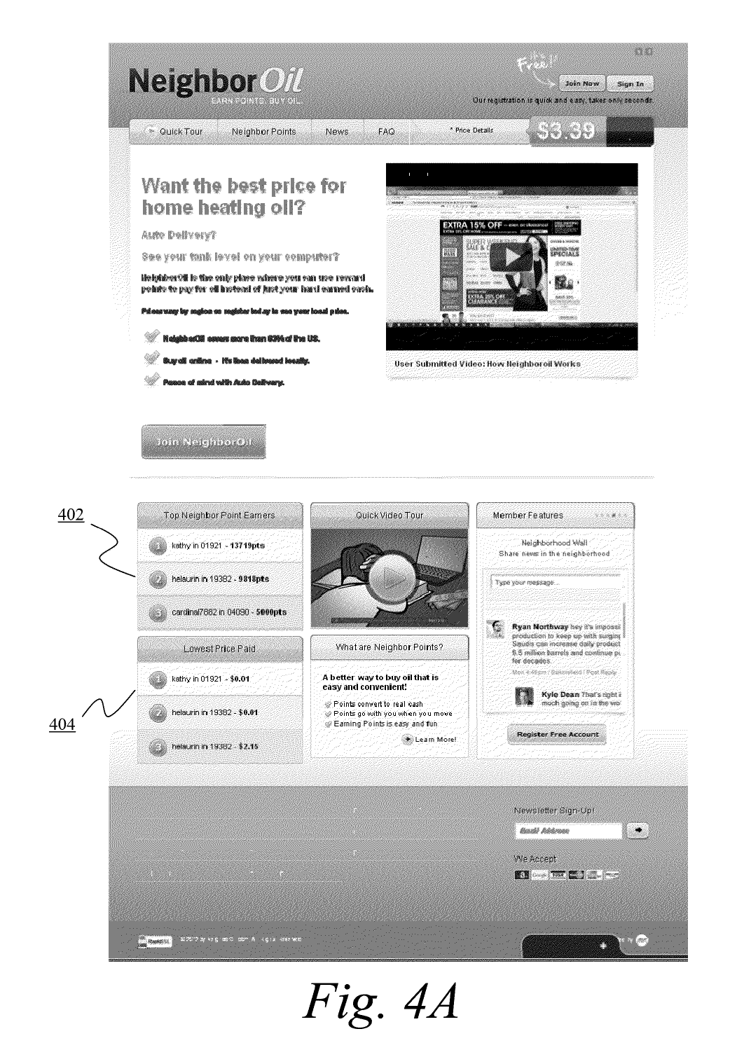

Referring now to FIG. 3, illustrated is a block diagram of a system for improved commodity pricing and sales. In brief overview, a client computing device 300 executed by a user or consumer may connect via a network, such as the Internet, to a host or server computing device executed by a commodity retailer 310, sometimes referred to as a commodity purchase portal, a commodity intermediary, an intermediary retailer, or via similar terms. In some embodiments, client 300 may comprise an application 302, such as a web browser or application communicating with commodity retailer 310. In a further embodiment, client 300 may comprise a client agent 304. The server computing device executed by commodity retailer 310, referred to herein as commodity retailer 310, may comprise, in some embodiments, a portal 312, a security module 314, a customer database 316, a pricing engine 318, and a billing engine 320. In some embodiments, commodity retailer 310 may comprise a social network service 322, such as a blog, forum, or other service. In some embodiments, client 300 and/or commodity retailer 310 may communicate via a network with a third-party social network service 324. Commodity retailer 310 may also communicate with one or more wholesale commodity providers or local providers 326, and, in some embodiments, one or more carbon offset certificate providers 328. Although illustrated as a single server 310, in many embodiments, one or more modules of server 310 may be executed by separate servers, by a server farm, by virtual machines hosted in a cloud service, or via other similar means.

Still referring to FIG. 3 and in more detail, in some embodiments, a first computing device 300, referred to variously as a client, computing device operated on behalf of a user, mobile computing device, remote computing device, or via similar terminology may connect via a network to a second computing device 310, referred to variously as a server, host computing device, computing device operated on behalf of a commodity retailer, or commodity retailer 310 or via similar terminology. The network may comprise any type or form of network, such as those discussed above. In some embodiments, the client computing device 300 may execute an application 302 for communicating with server 310. Application 302 may comprise an application, service, daemon, routine, or other executable logic. In some embodiments, application 302 may comprise a web browser, while in other embodiments, application 302 may comprise a dedicated communication application, widget, desktop application, or other application. In embodiments in which client 300 comprises a smart phone, tablet, or other mobile computing device, application 302 may comprise an “App” or dedicated application for communicating with server 310.

In some embodiments, client 300 may execute a client agent 304. Client agent 304 may comprise an application, service, daemon, routine, or other executable logic for monitoring interactions of a user of client 300 and communicating interactions to server 310. In some embodiments, client agent 304 may comprise functionality for receiving notifications of potential point earning opportunities and communicating the notifications to a user of client 300. For example, in one embodiment, client agent 304 may comprise a toolbar application or extension executed by a web browser 302. The toolbar may comprise functionality for monitoring a user's interactions with third party websites. In some embodiments, the toolbar may communicate notifications of the interactions to server 310, and receive identifications of opportunities or points earned. An interaction may comprise visiting a third party website; purchasing goods; reviewing a product; posting to a blog or forum; positively marking the website, such as with the “like” function or “+1” function provided by the Facebook social networking service provided by Facebook, Inc., or the Google+ social networking service provided by Google, Inc., respectively; or performing other interactions with third party websites. In one embodiment, for example, the toolbar may determine that the user has visited a website of a specific clothing retailer. In some embodiments, the toolbar may communicate an identification of the website to server 310. Server 310 may identify the website as belonging to a third-party retailer that has partnered with the commodity retailer, and may identify one or more point opportunities associated with the third-party retailer. For example, a point opportunity may comprise an opportunity for the user to earn a predetermined amount of points for every n dollars spent at the third party retailer's website. Server 310 may transmit an identification of the opportunity to the client agent 304 for display to the user. The client agent 304 may monitor the user's further interactions with the site, such as placing an order or performing other functions that are associated with point opportunities, and may transmit notifications to server 310 of the user's point-earning notifications. For example, in one such embodiment, a user may visit an online book seller. The client agent 304 may transmit an identification of the seller to server 310, which may search a point opportunity database for associated opportunities. Upon finding an opportunity, server 310 may transmit an identification of the opportunity and relevant information to client agent 304, such as “10 points for every $3.20 purchased” or “5 points for every book review left at the site” or “1 point for each third-party review identified as helpful or not helpful” or any other similar opportunities. In many embodiments, such information may be encoded as data strings identifying elements of the site, such as POST tags associated with forms. The client agent 304 may present the opportunity or opportunities to the user, such as via a pop-up window, balloon notification, scrolling notification in a status bar, or other user interface elements. The client agent 304 may monitor the user's interactions with the site or with identified elements of the site, may parse shopping carts or checkout receipts, or perform similar functions for identifying when a user has earned points by meeting the requirements of the point opportunity. In some embodiments, client agent 304 may transmit a notification of the earned points or fulfilled opportunity to server 310 for crediting a point balance of the user's account, and may present the user with an identification of the points earned. In many embodiments, client agent 304 may comprise functionality for logging into or supplying user credentials to server 310 by the user, so that earned points may be associated with the user. In a further embodiment, client agent 304 may display a current point balance for the user, the point balance retrieved from server 310. In many embodiments, client agent 304 may remain logged in to server 310 or save login information for re-use, even as the user closes web pages associated with server 310.

In some embodiments, client agent 304 may comprise a database of point opportunities, and as such, may not need to communicate with server 310 to identify point opportunities at third-party retailer sites and notify the user. In a further embodiment, client agent 304 may receive periodic notifications or updates from server 310, identifying new point opportunities or removing expired opportunities. This may reduce bandwidth required. In still other embodiments, client agent 304 may identify point opportunities responsive to code within the third-party retailer's web page or on a related page, such as within XML code. For security against unaffiliated third-party retailers inducing users to spend money with misleading or false point opportunities, client agent 304 may transmit an identification of the identified point opportunities to server 310 for verification. In one embodiment, such identification may comprise a hash of the point opportunity, reducing bandwidth required.

In some embodiments, in addition to visiting third-party retailers, a user may use client 300 to communicate with social networking services 324, such as Facebook or Google+. As discussed above, client agent 304 may monitor user interactions with social networking services 324, such as posting to forums or blogs, commenting or discussing with others, or positively rating elements. In some embodiments, client agent 304 may monitor forum posts or comments for words or phrases related to the commodity retailer, such as “heating oil,” “energy consumption,” “green energy,” “electricity,” “points,” the retailer name, or other phrases that indicate the user is discussing the commodity retailer. Point opportunities may be associated with discussing the commodity retailer, as a way to increase word-of-mouth advertising. In one embodiment, points may be awarded based on the number of mentions within a post, or the number of posts including mentions. In some embodiments, to discourage spamming, points may be reduced or not granted for messages that simply contain the related words, or for messages that include a high number or high proportion of related words. In some embodiments, client agent 304 may parse messages for positive words or negative words, such as “like,” “dislike,” or similar phrases to indicate whether a message encourages or discourages others from visiting the retailer's site.

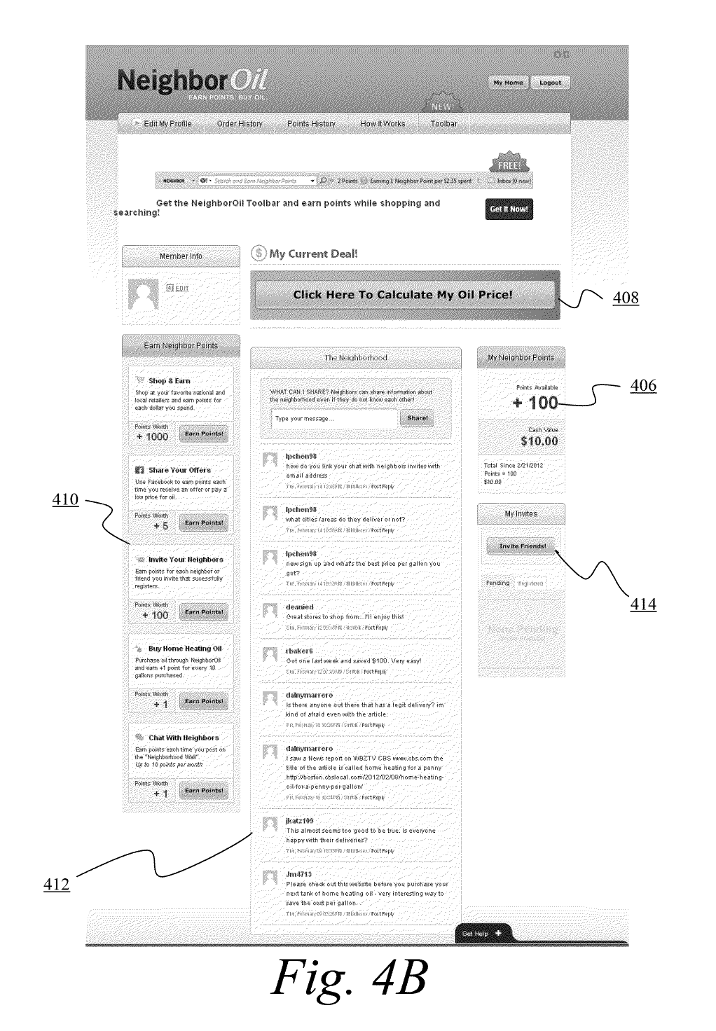

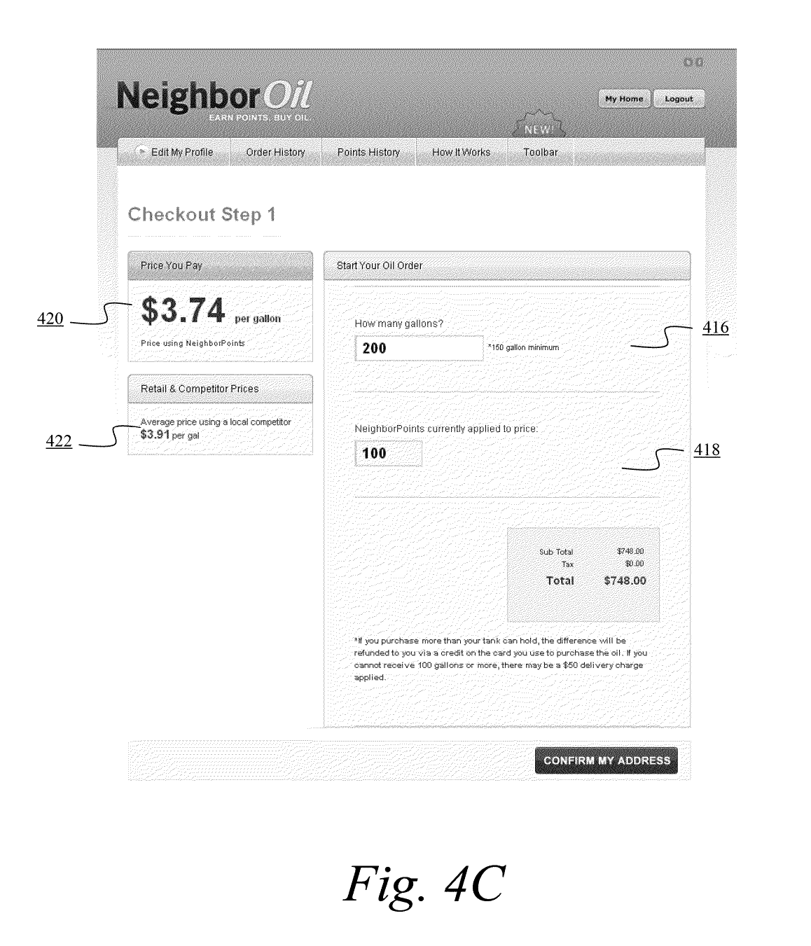

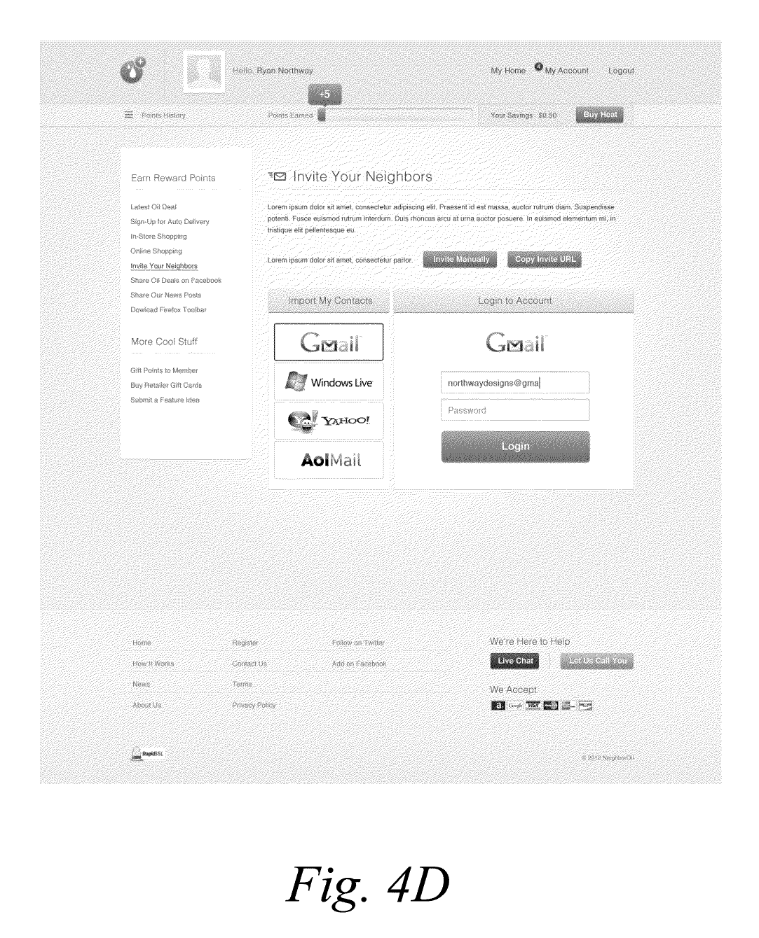

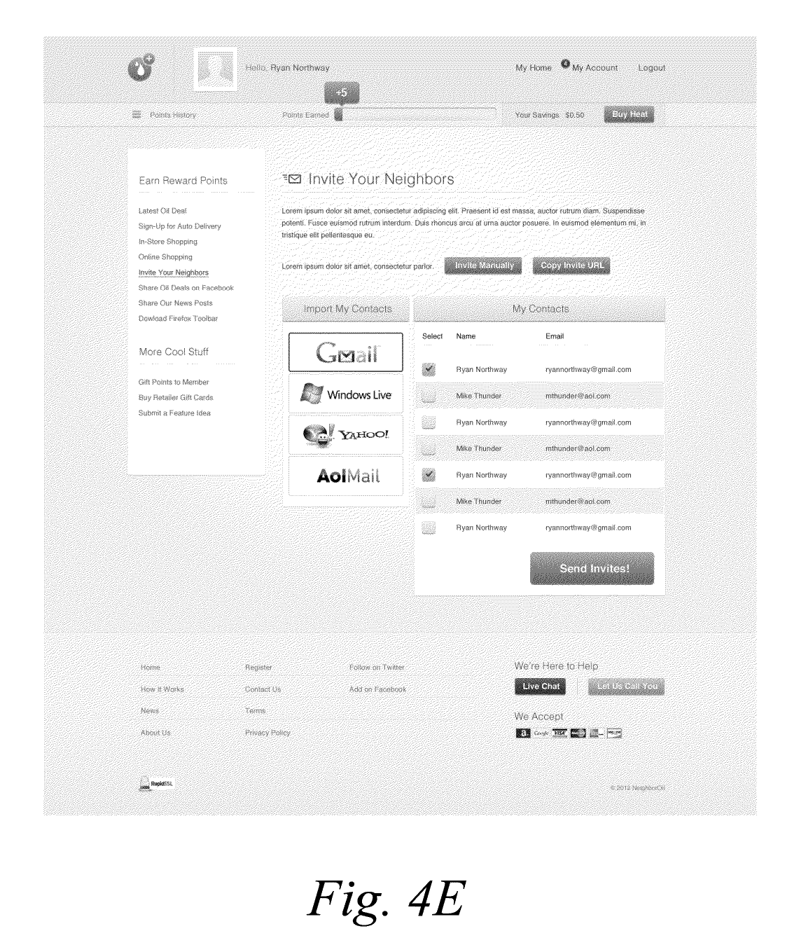

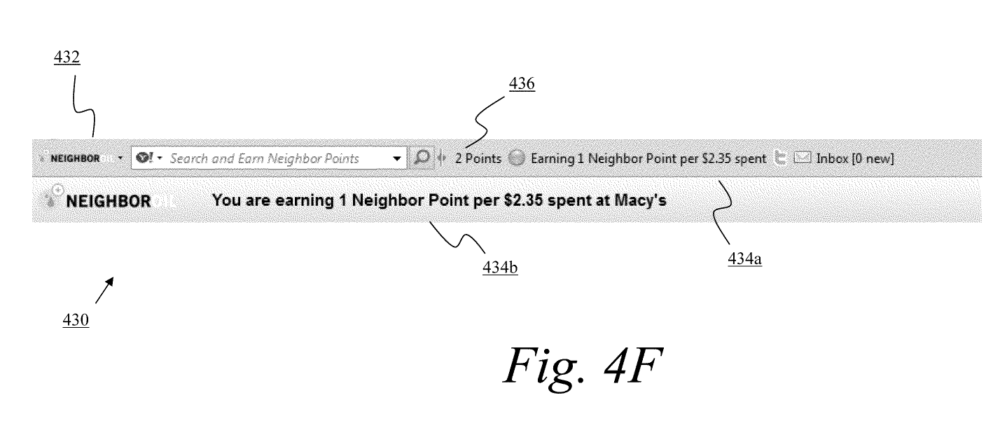

In some embodiments, server 310 may comprise a portal 312. Portal 312 may comprise an application, service, web page, script, or other interface for allowing a user to log in, interact with features provided by server 310, monitor the user's point balance, place an order for one or more commodities or services, or perform other functions. For example, referring briefly ahead to FIGS. 4A-4E, illustrated are example screenshots of embodiments of a portal 312 for the systems and methods discussed herein. As shown in FIG. 4A, a portal may comprise a landing page or initial page viewed by visitors or users. The portal may provide functionality for signing up and/or logging in (e.g. providing user credentials, passwords, address information, etc.). In some embodiments, the portal may identify top point earners 402 and/or the lowest price paid for a commodity by users 404 to encourage consumers to participate.

FIG. 4B is an example screenshot of an embodiment of the portal displayed after a user or consumer has logged in. In some embodiments, the page may comprise an identification of the user's current point balance 406; a link to purchase an amount of a commodity 408; an identification of one or more current point opportunities 410; a social network service 412 such as a forum, wall, feed, or similar service; or a link to invite friends to join the service 414. Responsive to a user requesting to purchase an amount of a commodity, the portal may display a price display and confirmation page as shown in the example embodiment depicted in FIG. 4C. In some embodiments, the price display and confirmation page may comprise fields for allowing the user to specify an amount of the commodity to purchase 416, such as gallons of fuel or kilowatt hours of electricity. In some embodiments, the user may specify a number of points to apply to the order 418, while in other embodiments, some or all of the user's points may be applied automatically. In some embodiments, the portal may display a calculated price for the user 420 and/or a default price 422. The calculated price may comprise a reduced price based on the market rate for the amount of the commodity purchased, reduced by any bulk discount applied for large orders, and further subsidized or reduced by applying points.

In some embodiments, as shown in the example screenshots of embodiments depicted in FIGS. 4D and 4E, a user may invite friends to join the service. In many embodiments, the user may log in to a third party service, such as an email provider, and the portal may retrieve an address book from the third party service so that the user may select friends to invite.

As discussed above, in many embodiments, a client agent executing on the consumer's computing device may comprise a toolbar, as shown in the example screenshot of an embodiment of a client agent user interface 430 depicted in FIG. 4E. Client agent user interface 430 may comprise a toolbar 432, including search functionality and access to email or social networking services. In some embodiments, responsive to the user visiting a third-party retailer, as discussed above, the client agent may display an identification of a point opportunity 434a-434b to the user, referred to generally as identifications of point opportunities 434. The identification of the point opportunity 434 may comprise a text status within the toolbar as shown at 434a, or may comprise a status bar that extends from toolbar 432, as shown at 434b. In some embodiments, the extending bar may be animated to display when the user first visits the site, and then retract after a predetermined time period. In some embodiments, the user interface may display a current point balance 436 or a total number of points earned at the third party site during the session.

Returning to FIG. 3, in some embodiments, a server 310 may comprise a security module 314. Security module 314 may comprise an application, service, server, daemon, or other executable logic for receiving and verifying user credentials against a customer database 316. Security module 314 may comprise functionality for allowing a user to register or log in through portal 312 to interact with server 310.

In some embodiments, server 310 may comprise a customer database 316. Customer database 316 may comprise a database, flat file, array, or other data file for storing identification of consumers, customers, or users. In some embodiments, database 316 may be stored on server 310, while in other embodiments, database 316 may be stored on a separate storage server, external storage device, or in a network storage system. Database 316 may comprise identifications of each user, login name or account name, password, real name, address, point balance, credit card or bank account information, third-party service credentials such as email account or social network service account credentials. In some embodiments, database 316 may further comprise data regarding commodity consumption by the user, including amounts ordered or consumed over various time periods, order histories, or other information. In still other embodiments, database 316 may comprise data regarding a user's interactions with third-party services to earn point opportunities, such as an amount spent at a third-party retailer over various time periods or an amount earned for actions taken through social networking accounts of the user. This may be valuable for targeted marketing, demographic analysis, or other similar functions.

In some embodiments, the server 310 can track the users activities at third party retail locations and websites. In some embodiments, the service may receive a request from the user to earn points by shopping at a particular third party retail store. In some embodiments, the server may track the user's activities by tracking the user's retail activity via the user's store loyalty card for that particular store. In some embodiments, the server may require that the user register the store loyalty card with the server 310. In some embodiments, server 310 may issue a store loyalty card for the user electronically and the retailer may provide the store loyalty card to the consumer. In some embodiments, server 310 may issue a store loyalty card for the user that can be used at one or more of the third party retail stores or websites that have partnered with the commodity retailer. In some embodiments, upon registering or creating the store loyalty card, the user can select one or more point earning opportunities provided by the server at the particular third party retail store or website. Once the user selects the one or more point earning opportunities, the server 310 activates the selected point earning opportunities for the user. As such, any purchases the user makes after the point earning opportunities are activated can be rewarded with points that can be used to pay for the one or more services provided by one or more of the providers 326.

In some embodiments, service 310 may execute a pricing engine 318. Pricing engine 318 may comprise an application, service, daemon, or other executable logic for calculating point balances responsive to receiving identification of a user fulfilling a point earning opportunity, and calculating reduced prices for a commodity responsive to point balances or subsidizing of the commodity via points. In some embodiments, points may be worth a predetermined amount based on a points conversion schedule, and pricing engine 318 may reduce a price to be paid by a consumer for a commodity order by deducting the amount of a cash value corresponding to the points being converted from a calculated total for the order. For example, given a commodity with a market price of $4 per unit, and a consumer ordering 200 units, pricing engine 318 may calculate a gross price of $800. If the consumer has 200 points worth $0.50 each according to a price conversion schedule and the consumer selects to convert the 200 points to a cash value, the pricing engine 318 may reduce the gross price by the cash value, which is a corresponding $100. In some embodiments, pricing engine 318 may calculate an updated price responsive to the reduction for display to the consumer. In some embodiments, pricing engine 318 can calculate a net price per unit by dividing updated price with the number of units purchased. For example, given the above amounts, the pricing engine may display a net price of $3.50 per unit, or that the consumer has saved $0.50 per unit through the use of points. In some embodiments, pricing engine 318 may apply bulk discounts to large orders, and/or may calculate taxes and delivery fees. In some embodiments, pricing engine 318 may determine the market price for the commodity. In one embodiment, the market price may be based on one or more local provider prices for the commodity, or may comprise an average of said local provider prices. In another embodiment, the market price may be based on a wholesale price from a wholesale commodity provider, and further based on a predetermined profit margin for local providers and the intermediary retailer. For example, in one such embodiment, a wholesale price of $3 per unit may be marked up to $4 per unit as market price, responsive to a 33% markup divided between the local provider and the intermediary retailer.

The consumer retailer may use monies received or credited from third-party web-site affiliates/partners, service providers and/or advertisers to support, provide or enable the conversion of points to cash value or credit to the consumer. The retailer may receive monies or credits from the difference in whole sale price offered to the retailer by the service provider and retail price offered to the consumer. The retailer may receive monies or credits from third-party web site affiliates or partners corresponding to or based on a number of points that the consumer retailer will provide or give to the consumer for the purchase. The retailer may receive monies or credits from third-party web site affiliates or partners based on the amount of purchase by the consumer via the third-party web site. The retailer may receive monies or credits via subsidiaries from the service provider and/or third party web site. The retailer may receive monies from advertisers for advertisement, such as to the consumers via the retailer's web-site. Via the collection of, accounting of or consideration of the monies and credits from these different sources, the consumer retailer can determine how to convert points to cash, how to price services while making a profit

In some embodiments, server 310 may comprise a billing engine 320. Billing engine 320 may comprise an application, service, server, daemon, routine, or other executable logic for billing a consumer responsive to an order. In some embodiments, billing engine 320 may interface with third-party payment systems, such as credit card providers or banks. In many embodiments, billing engine 320 may further comprise functionality for issuing payments to local providers responsive to orders. In some embodiments, responsive to receiving a commodity or service order from a consumer, billing engine 320 may identify a local provider capable of delivering the commodity or service to the consumer with a lowest unit price out of a plurality of local providers. Such unit prices may be highly volatile, as discussed above. Accordingly, billing engine 320 may retrieve current prices from the plurality of local providers and select a provider with a lowest price for receipt of the order. Thus, a customer may automatically receive the lowest price without effort by the customer. In other embodiments, the customer price may be based off a calculated market price, and the intermediary retailer may select a local provider with a lowest price in order to increase the intermediary retailer's profit margin without increasing customer cost. In some embodiments, as discussed above, billing engine 320 may comprise functionality for placing periodic or automatic orders for a commodity for a consumer, responsive to consumer tank supply thresholds, consumption rates, consumer order history, or environmental factors such as ambient temperature and/or weather.

In some embodiments, server 310 may execute a social network service 322, such as a forum, blog, news feed, or other service, as illustrated in the screenshot of FIG. 4B. In some embodiments, users may earn points by taking actions, such as posting messages or providing indications of approval on the service 322 or otherwise interacting with the service 322. As discussed above, in many embodiments, users may similarly earn points by interacting with external social networking services 324 or third party retailers.

Server 310 may communicate with one or more providers 326. In some embodiments, providers 326 may comprise one or more wholesale providers, and/or one or more local providers. In some embodiments, depending on the type of commodity or service requested, the providers can be remote providers, for example, health or auto insurance providers that may be located elsewhere but are capable of providing health or auto insurance to a consumer. In some embodiments, server 310 may communicate with wholesale providers to identify market wholesale prices for a commodity paid by local providers, such that pricing engine 318 and/or billing engine 320 may identify a market price. In other embodiments, server 310 may communicate with local providers to identify local provider retail prices and bulk discount information, and place orders and provide payments to local providers for delivery of commodities to consumers.

In some embodiments, server 310 may communicate with one or more carbon offset certificate providers 328. Consumers may elect to purchase carbon offset certificates during purchase of commodities to reduce their carbon footprint. This allows a user to automatically offset their purchase, at the time of ordering.

In some embodiments, point earning and purchase history for a consumer may be tracked by the system to customize incentives and offers, reward points based on the tracked data, or perform other functions. For example, in one embodiment using home storage tanks for heating oil, a tank monitor may be placed on the tank. The tank monitor may comprise a level meter and a wired or wireless communication device, which may transmit readings of tank levels to the consumer and/or the intermediary retailer. In one embodiment, the monitor may comprise a tank cap with an integrated monitor and WiFi transceiver for connecting to the consumer's home wireless network and/or desktop or laptop computer. The user may, in some embodiments, use an application to view tank level readings, allowing the user to monitor consumption and manually purchase based on reserve amounts. In other embodiments, the level may be transmitted to the intermediary retailer, for automatic purchase and delivery when the level drops below a user-set threshold. Similarly, in embodiments in which the commodity is natural gas or electricity, a monitor or meter may be installed at the consumer's location, such as a gas meter or electricity meter, that may transmit readings to the consumer's computing device, the provider, and/or the intermediary retailer. In other embodiments, consumption may be monitored based on provider delivery amounts. Thus, the intermediary retailer may monitor a consumer's consumption based on the user's purchase history over a predetermined time. For example, in one embodiment in which the commodity is online movie rentals from service providers such as the iTunes Video Store provided by Apple, Inc. or the Blockbuster online rental service provided by Blockbuster, LLC, the intermediary retailer may monitor the frequency, type, and cost of purchases. In embodiments in which consumption of the commodity is not easily measured, such as internet service or phone service, the intermediary retailer may track usage statistics from the local provider, such as bandwidth or minutes.

In one embodiment, tracked data on a consumer's consumption history or point earning history may be used for marketing purposes or for generating targeted offers. For example, if the intermediary determines that the consumer regularly purchases from a particular third-party retailer, the intermediary may notify the consumer of additional exclusive point earning opportunities through sales at the third-party retailer. These point earning opportunities may be subsidized by the third-party retailer (e.g. the retailer may pay the intermediary a fee for each user taking advantage of the opportunity through purchases from the retailer). In some embodiments, the tracked data may be used for recommendations for conservation measures. For example, if the intermediary notes that the consumer has a higher than average rate of consumption, the intermediary may send conservation tips to the consumer to reduce costs. In other embodiments, tracked data may be used for personalized recommendations for longer term contracts. For example, if the intermediary notes that the consumer repeatedly exceeds a number of minutes on a phone service contract or bandwidth on an internet service contract, the intermediary may send the consumer recommendations for contracts with higher or no caps.

Although the systems and methods described herein may at times be generally described in terms of purchase and/or delivery of a commodity or fuel resource such as oil, these systems and methods may be used to earn and redeem points towards the purchase and/or delivery of any type and form of service, including in home services and local delivery services. These services may include any type of service delivered to the home, such as but not limited to telecommunication services, transportation services, food delivery services, home repair services, home maintenance services and installation services. These services may include any type of service delivered locally to the purchaser or consumer, and not necessarily at the home of the purchaser or consumer, such as car washing services, educational services and dry cleaning services.

These services may include any type of service related to health care, including but not limited to health care insurance, hospital services, doctor services, co-payments for visits to health care provider, chiropractor services, rehabilitation services, physical therapy, prescriptions, etc. As such, in some embodiments, points earned such as by everyday shopping via the systems and methods of the platforms described herein, consumer may earn points and convert them to cash for payment to any health care related service.

These services may include any type of service related to telecommunications, including but not limited to cell phone, smart phone, table or mobile device purchase and related services, including monthly service charges for cellular, wifi, data, etc. As such, in some embodiments, points earned such as by everyday shopping via the systems and methods of the platforms described herein, consumers may earn points and convert them to cash for payment to any telecommunication related product and/or service, such as purchase of a new smart phone or mobile device, or upgrading to the same.

For example, utilizing the systems and methods of the platform described herein, a telecommunications related retailer or service provide may create a program where they can offer a new “mobile” reward platform to partners (such as telecommunication carriers) so that the partners users may access an instance of the platform for the purpose of converting a portion of everyday spend to credits on their purchase of an upgraded phone and/or minutes. For example, the program may provide the following promotion as an example: “Buy a gallon of milk and earn 10 credits towards the purchase of an iPhone 4 which costs 200 credits.” The instance of the platform could be branded as the carrier and the credits would be integrated into the checkout of the carriers website or other means upon to effectuate the process. By enabling such telecommunication retailer and service provide with the ability to offer a reward/incentive program to carriers to drive both higher ticket (e.g. purchase better phones on pre-paid) and also drive loyalty so that with better phones, pre-paid users stay with the carrier longer thereby increasing margin to the carrier

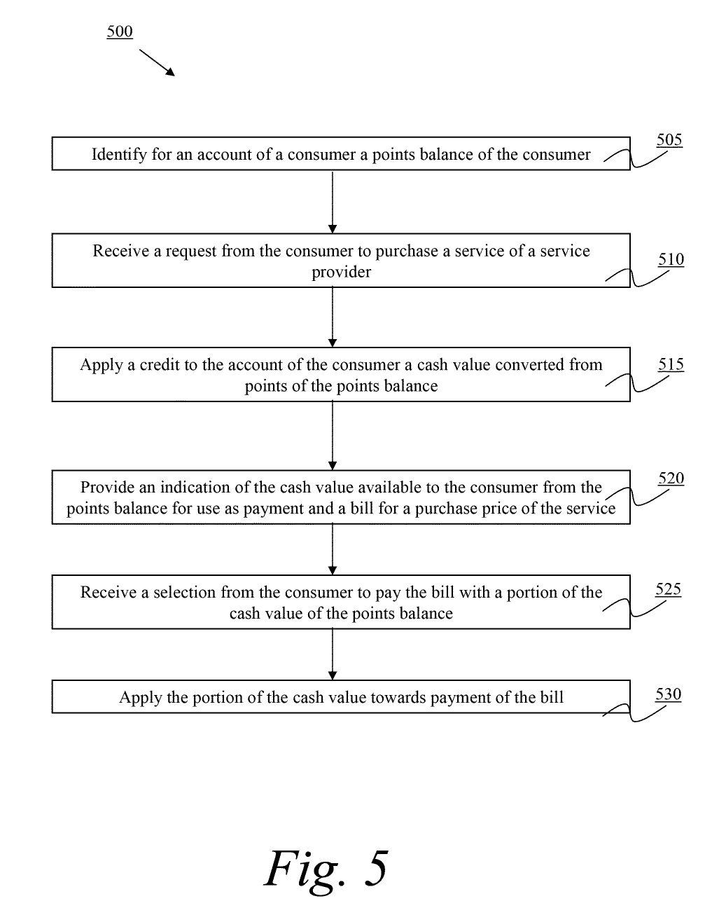

FIG. 5 provides a flow diagram of an embodiment of a method for using cash credits earned from consumer activity to pay for a purchase of a service of a service provider. In brief overview, at step 505, a retailer acting as an intermediary between a plurality of consumers and one or more service providers (e.g., intermediary or intermediary retailer) identifies for an account of a consumer of the plurality of consumers maintained by a server a points balance of the consumer. At step 510, the retailer receives a request from the consumer to purchase a service of a service provider of the one or more service providers for which the commodity retailer acts as the intermediary. At step 515, the retailer credits to the account of the consumer a cash value converted from points of the points balance. At step 520, the retailer provides an indication of the cash value available to the consumer from the points balance for use as payment and a bill for a purchase price of the service. At step 525, the retailer receives a selection from the consumer to pay the bill with a portion of the cash value from the points balance. At step 530, the retailer applies the portion of the cash value towards payment of the bill for the purchase price of the service.

In further details of step 505, the retailer, such as a commodity retailer using the systems and methods described herein, identifies for an account of a consumer maintained by the retailer a points balance of the consumer. In some implementations, the retailer maintains accounts for each consumer who has registered with the services of the retailer. The consumer account can include identifying information that identifies the consumer, personal and contact information of the consumer, information associated with one or more accounts, including social networking accounts, of the consumer as well as information associated with actions taken by the consumer external to and tracked by the commodity retailer. In some embodiments, the retailer receives identification of amounts of purchases made by the consumer at one or more third party web-sites not related to the one or more service providers. In some embodiments, the third party web sites can have a relationship (such as contractual or business relationship) with the commodity retailer, for example, the third party web sites can be partners or affiliates. However, the third party web site may have not have a relationship with the service providers that the retailer allows consumers to purchase services using points. For example, the points earned by the consumer are not from purchases with the service providers available via the commodity retailer—that is, the service provider is not providing points for purchases to the consumers to use towards future purchases with that service provider. Instead, the consumer earns points via activity from other providers and retailers not related to the service provider. For example, the consumer may earn points by the commodity retailer for purchases at a grocery store, wholesale club or clothing store and apply those points for cash to pay a bill to a heating oil provider.

In some embodiments, the account also includes a points balance. The points balance indicates a total number of points that are earned by the consumer by taking actions that have yet to be redeemed for a cash benefit. The points balance may identify a history of each of the points earned and how, when and where they were earned.

In some embodiments, the retailer can identify actions taken by the consumer that are recognized by the retailer and systems thereof to earn points. In some embodiments, the retailer can provide points to the consumer for the actions taken by the consumer. In some embodiments, the actions are not related to the one or more service providers. In some embodiments, the actions can be taken external to the retailer. For example, the actions can be taken on a social networking site, at a third party retailer, at a brick and mortar store, at a neighborhood or on an online forum. Examples of actions that can be tracked include online shopping, offline shopping, and social networking activity, such as providing an indication of approval (“like”, “+1”), posting a message or a comment, sharing a link, amongst others. Other examples of actions include referring other consumers to the retailer or discussing aspects of the retailer with others. Other examples of actions can be based on how the service is consumed, the amount of consumption of the service or commodity, amongst others. In some embodiments, the retailer can receive activity information via a toolbar or other such program, application or software installation that can track the activity of the consumer online. In some embodiments, the retailer can also receive information from the consumer's social networking accounts and other Internet websites. The retailer can assign points for each activity according to a points policy. In some embodiments, the points policy awards points for the tracked activity according to a points schedule. In some embodiments, the consumer can have a points balance which can be updated to include points earned by the consumer.

At step 510, the retailer receives a request from the consumer to purchase a service of a service provider. The retailer may provide via one or more servers a user interface, such as via serving one or more web pages, that displays the services of the multiple services providers for which the retailer sells services. The retailer may provide a user interface that displays the different type of services available via the retailer. The retailer may provide a user interface that displays the different service providers available via the retailer. The retailer may provide a user interface that displays the different service providers for each of the different services available via the retailer. The retailer may provide a user interface that display the pricing per service and/or service provider.

Via the user interface of the server of the retailer, a consumer may browse, view and select one or more services to purchase and submit a request to purchase. The request may be provided via a shopping cart or checkout. Via the user interface of the server of the retailer, a user may add one or more services to a shopping cart. The user may select one or more services and initiate a checkout process via the retailer. In some embodiments, the request is to purchase a service of a service provider for which the retailer acts as the intermediary to process payments from the consumer for purchases of the service of the service provider. In some embodiments, the request can include request(s) to purchase one or more services from one or more service providers. In some embodiments, the request identifies a service without identifying a particular service provider. In some embodiments, the request includes additional details related to the service, including a quantity, a delivery date and time, amongst others.

At step 515, the retailer credits a cash value converted from points of the points balance to the account of the consumer. The retailer may credit the cash value responsive to a consumer's request, such as upon receiving a request to purchase a service. The retailer may credit the cash value automatically on a predetermined schedule or every time the consumer visits the consumer's account. In some embodiments, the points can be converted to a cash value. In some embodiments, the consumer selects an amount of points from the points balance to convert or redeem to a cash value or credit.

The retailer can convert points according to a points conversion schedule. For example, the points can be converted to a cash value that can be applied towards payment of a bill for a service provided by one of the service providers for which the retailer acts as an intermediary. In some embodiments, the retailer identifies a number of points in the points balance and multiplies the number of points by a points-to-cash conversion rate to generate the cash value. The points to cash conversion schedule may be specified at any granularity, such as on a per service basis, on a per service provider basis, a per consumer basis and/or a on per point redeeming activity (e.g., per third party web-site or per type of action taken). The retailer designated, adds or identifies the cash value to the account of the consumer and remove the points used to generate the cash value from the points balance. In some embodiments, the cash value or cash credit is only redeemable for payments towards services available via the retailer.

At step 520, the retailer provides an indication of the cash value available to the consumer from the points balance for use as payment and a bill for a purchase price of the service. In some embodiments, the retailer provides the indication of the cash value in response to receiving a request to purchase a service from the consumer. In some embodiments, upon receiving the request to purchase a service from the consumer, the retailer can generate a bill for the service. In some embodiments, the retailer can generate a bill for the service in which the service is priced lower than a price the consumer would have paid had the consumer purchased the service directly from the service provider. In some embodiments, the retailer receives service prices from a plurality of service providers. In some embodiments, the retailer receives service prices from a plurality of service providers responsive to providing the service providers information about the request to purchase a service that is received from the consumer. Examples of the information can include consumer information, a delivery address, a quantity, a delivery time and date, amongst others. In some embodiments, the retailer can generate a bill for the service in which the service price is a predetermined amount, such as an amount greater than a price at which the service provider has agreed to provide the service to the retailer's customers. For example, the predetermined amount can be a percentage, such as 10% for example, or a fixed amount per unit of service, such as $2/unit. The retailer can determine the cash value available to the consumer from the points balance according to the points conversion schedule. In some embodiments, the retailer may retrieve current prices from the plurality of service providers and select a provider with a lowest price for receipt of the order. In this way, a consumer may automatically receive the lowest price without effort by the consumer. In other embodiments, the consumer price may be based off a calculated market price, and the retailer may select a local provider with a lowest price in order to increase the intermediary retailer's profit margin without increasing customer cost.

At step 525, the retailer receives a selection from the consumer to pay the bill with a portion of the cash value from the points balance. In some embodiments, the retailer receives the selection from the consumer in response to providing an indication of the cash value available to the consumer from the points balance for use as payment and a bill for a purchase price of the service. In some embodiments, the consumer selects pays the entire bill with cash value from the points. In some embodiments, the consumer selects and uses all of the available cash value towards payment. In some embodiments, the consumer selects a portion of the available cash value and use that portion towards payment.

At step 530, the retailer applies the portion of the cash value towards payment of the bill for the purchase price of the service. In some embodiments, the retailer then provides an updated amount to be paid corresponding to a difference between an amount of the bill and the portion of the cash value applied towards the bill. In some embodiments, if the selected cash value available is not enough to pay the bill for the service, the consumer pays any remainder via other means, such as credit card, cash, invoice, bill, etc. With the combination of cash value and other form of payment, the retailer pays for the service on behalf of the consumer. In some embodiments, the cash value is sufficient to cover the payment of service and the retailer pays for the service on behalf of the consumer. Via the systems of the retailer that interface to any one or more service providers, the retailer may electronically submit payment to the service provider. Via the systems of the retailer that interface or communicate to any one or more service providers, the retailer may electronically make the transaction for purchase of the service with the service provider, including making payment to the service provider.

In some embodiments, upon the bill being paid in full, the retailer notifies the consumer that the request to purchase the service is successful. In some embodiments, the retailer can then notify a service provider to provide the service to the consumer. In some embodiments, the retailer may then reveal the identity of the service provider that is providing the service, to the consumer.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of methods and systems for providing systems and methods for molecular analysis of adverse event data, it will now become apparent to one of skill in the art that other embodiments incorporating the concepts of the invention may be used.

It is claimed:

1. A method for using cash credits earned from consumer activity to pay for a purchase of a service of a service provider, the method comprising:
(a) identifying, by a server acting as an intermediary between a plurality of consumers and one or more service providers, for an account of a consumer of the plurality of consumers maintained by the server, a points balance of the consumer, points of the point balance earned by the consumer by taking actions, external to and tracked by the server, not related to the one or more service providers;
(b) receiving, by the server, a request from the consumer to purchase, via the server, a service of a service provider of the one or more service providers for which the server acts as the intermediary to process payments from the plurality of consumers for purchases of one or more services of the one or more service providers;
(c) crediting, by the server, to the account of the consumer a cash value converted from points of the points balance, the cash value applicable as payment to the one or more service providers for the purchase of one or more services;
(d) providing, by the server responsive to the request to purchase the service, an indication of the cash value available to the consumer from the points balance for use as payment and a bill for a purchase price of the service; and
(e) applying, by the server responsive to the consumer selecting to pay the bill with at least a portion of the cash value from the points balance, the portion of the cash value towards payment of the bill for the purchase price of the service.

2. The method of claim 1, wherein step (a) further comprises
receiving, by the server, actions taken by the consumer at one or more third party web-sites not related to the one or more service providers;
assigning, by the server, points to each of the actions; and
updating, by the server, the points balance of the consumer to include the assigned points.

3. The method of claim 1, wherein receiving actions taken by the consumer include receiving actions taken by the consumer through one or more social network accounts of the consumer.

4. The method of claim 1, wherein receiving actions taken by the consumer include receiving identification of amounts of purchases made by the consumer at one or more third party web-sites not related to the one or more service providers.

5. The method of claim 1, wherein step (c) further comprises
identifying, by the server, a number of points in the points balance;
multiplying, by the server, the number of points by a points-to-cash conversion rate to generate the cash value;
adding, by the server, the cash value to the account of the consumer; and
removing, by the server, the points in the points balance used to generate the cash value.

6. The method of claim 1, wherein step (b) further comprises receiving, by the server, the request to purchase, the service capable of being provided by more than one service provider of the one or more service providers.

7. The method of claim 1, wherein step (d) further comprises:
identifying, by the server, the service providers of the one or more service providers providing the service;
selecting, by the server, the service provider providing the service at a lowest price; and
providing, by the server, the bill corresponding to the selected service provider.

8. The method of claim 1, further comprises:
identifying, by the server, a lowest price at which one of the one or more service providers is willing to provide the service; and
determining a purchase price of the service responsive to identifying the lowest price, the purchase price being greater than the lowest price by a predetermined amount.

9. The method of claim 1, wherein step (e) further comprises providing, by the server, an updated amount to be paid corresponding to a difference between an amount of the bill and the portion of the cash value applied towards the bill.

10. The method of claim 1, wherein the one or more service providers includes any of the following: a heating oil provider supplying heating oil, an electric utility provider supplying electricity, a water supplier supplying water, a telephone company providing telecommunications services, an internet service provider providing internet services, a television cable company providing television-related services and a health care provider providing health care services.

11. A system for using cash credits earned from consumer activity to pay for a purchase of a service of a service provider, the system comprising:
a server acting as an intermediary between a plurality of consumers and one or more service providers
wherein the server is configured to identify for an account of a consumer of the plurality of consumers maintained by the account management module, a points balance of the consumer, points of the point balance earned by the consumer by taking actions, external to and tracked by the server, not related to the one or more service providers;
wherein the server is configured to receive, from the consumer, a request to purchase a service of a service provider of the one or more service providers for which the server acts as the intermediary to process payments from the plurality of consumers for purchases of one or more services of the one or more service providers;
wherein the server is configured to
credit to the account of the consumer, a cash value converted from points of the points balance, the cash value applicable as payment to the one or more service providers for the purchase of one or more services,
provide an indication of the cash value available to the consumer from the points balance for use as payment and a bill for a purchase price of the service responsive to the request to purchase the service, and
apply, responsive to the consumer selecting to pay the bill with at least a portion of the cash value from the points balance, the portion of the cash value towards payment of the bill for the purchase price of the service.

12. The system of claim 11, wherein the server is further configured to:
receive actions taken by the consumer at one or more third party web-sites not related to the one or more service providers;
assign points to each of the actions; and
update the points balance of the consumer to include the assigned points.

13. The system of claim 11, wherein the server is further configured to receive actions taken by the consumer through one or more social network accounts of the consumer.

14. The system of claim 11, wherein the server is further configured to receive amounts of purchases made by the consumer at one or more third party web-sites not related to the one or more service providers.

15. The system of claim 11, wherein the server is further configured to:
identify a number of points in the points balance;
multiply the number of points by a points-to-cash conversion rate to generate the cash value;
add the cash value to the account of the consumer; and
remove the points in the points balance used to generate the cash value.

16. The system of claim 11, wherein the server is further configured to receive the request to purchase, the service capable of being provided by more than one service provider of the one or more service providers.

17. The system of claim 11, wherein the server is further configured to:
identify the service providers of the one or more service providers providing the service;
select the service provider providing the service at a lowest price; and
provide the bill corresponding to the selected service provider.

18. The system of claim 11, wherein the server is configured to:
identify a lowest price at which one of the one or more service providers is willing to provide the service; and
determine a purchase price of the service responsive to identifying the lowest price, the purchase price being greater than the lowest price by a predetermined amount.

19. The system of claim 11, wherein the server is further configured to provide an updated amount to be paid corresponding to a difference between an amount of the bill and the portion of the cash value applied towards the bill.

20. A method for using cash credits earned from consumer activity to pay for a purchase of heating oil provided by a heating oil provider, the method comprising:
(a) identifying, by a server acting as an intermediary between a plurality of consumers and one or more heating oil providers, for an account of a consumer of the plurality of consumers maintained by the server, a points balance of the consumer, points of the point balance earned by the consumer by taking actions at one or more third party web-sites not related to the one or more heating oil providers;
(b) receiving, by the server, a request from the consumer to purchase, via the server, heating oil from a heating oil provider of the one or more heating oil providers for which the server acts as the intermediary to process payments from the plurality of consumers for purchase of heating oil of the one or more heating oil providers;
(c) crediting, by the server, to the account of the consumer a cash value converted from points of the points balance, the cash value applicable as payment to the one or more heating oil providers for the purchase of heating oil;
(d) providing, by the server responsive to the request to purchase the heating oil, an indication of the cash value available to the consumer from the points balance for use as payment and a bill for a purchase price of the heating oil; and
(e) applying, by the server responsive to the consumer selecting to pay the bill with at least a portion of the cash value from the points balance, the portion of the cash value to payment of the bill for the purchase price of the heating oil.
